(19) United States
(12) Patent Application Publication
(10) Pub. No.: US 2012/0314857 A1
(43) Pub. Date: Dec. 13, 2012

(54) BLOCK ENCRYPTION DEVICE, BLOCK DECRYPTION DEVICE, BLOCK ENCRYPTION METHOD, BLOCK DECRYPTION METHOD AND PROGRAM

(76) Inventor: Kazuhiko Minematsu, Tokyo (JP)

(21) Appl. No.: 13/579,863

(22) PCT Filed: Feb. 22, 2011
(86) PCT No.: PCT/JP2011/053832

§ 371 Date: Aug. 17, 2012

(30) Foreign Application Priority Data
Feb. 24, 2010 (JP) 2010038975

(51) Int. Cl. H04L 9/00

(52) U.S. Cl. 380/44

(57) ABSTRACT

A block encryption device receives b-bit tweak T and generates, by keyed hash function employing key K2, mask value S of n bits and intermediate value V of m bits, m being positive integer less than n/2; with block cipher being of block size of n bits, with key length being n bits and with tweak being of length of b bits; enhances intermediate value V to n bits on padding, and encrypts enhanced intermediate value V with block cipher of n bits, using key K1, to generate tweak dependent key L of n bits; and adds mask value S to plaintext of n bits to generate first value, encrypts first value with n-bit block cipher having tweak dependent key L as key to generate second value, and adds the mask value S to second value to generate ciphertext.

### CROSS-REFERENCE TO RELATED APPLICATIONS

1. Technical Field

This application is based upon and claims the benefit of the priority of Japanese patent application No. 2010-038975 filed on Feb. 24, 2010, the disclosure of which is incorporated herein in its entirety by reference thereto.

This invention relates to a block encryption device, a block decryption device, a block encryption method, a block decryption method and a program. More particularly, it relates to devices and methods for block encryption and decryption by an n-bit block cipher with an adjusting value, and a corresponding program.

2. Background

A block cipher is a set of permutations uniquely determined by a key. An input to and an output from permutation are termed a plaintext and a ciphertext, respectively. The length of the plaintext or that of the ciphertext is termed a block size. In general, the block cipher with the block size equal to n bits is termed an n-bit block cipher.

A block cipher with an adjusting value means a block cipher including, in addition to the plaintext, ciphertext and a key, a routine block cipher possesses as input/output, an adjusting value termed a “tweak.” The block cipher with the adjusting value is also termed a tweakable block cipher. In the block cipher with the adjusting value, it is required that, once the adjusting value and a key are fixed, there is a one-to-one correspondence between the plaintext and the ciphertext. That is, an encryption function. TWENC for a given block cipher with an arbitrary adjusting value and a corresponding decryption function TWDEC satisfy the following relationship:

C=TWENC(K,T,M) [symbol] M=TWDEC(K,T,C) (1)

where M denotes a plaintext, C a ciphertext, K a key and T an adjusting value, and an arrow [symbol] indicates that left and right propositions are equivalent to each other.

Non-Patent Literature 1 shows the formal definition of the block cipher with the adjusting value, including the equation (1), and a requirement for security. By the requirement for security is meant that, even if a tweak and an input are known to an attacker, outputs of two block ciphers with different tweaks appear to the attacker to be random values that are independent from each other. A tweakable block cipher is said to be secure when this requirement is satisfied.

Non-Patent Literature 1 also shows that a theoretically secure block cipher with the adjusting value may be obtained as a mode of operation, hereinafter abbreviated simply to a “mode,” of a routine block cipher, that is, as a conversion employing a block cipher as a black box. The theoretical security means that the security of a block cipher with the adjusting value, obtained as a mode of the block cipher, is attributed to the security of the underlying block cipher, that is, that the block cipher with the adjusting value, obtained with the use of the secure block cipher, is also secure.

Moreover, there are two types of the security definition, that is, security required when an attacker can make a chosen plaintext attack (Chosen-Plaintext Attack, called CPA) only, and security required when an attacker can combine a chosen plaintext attack and a chosen ciphertext attack (Chosen-Ciphertext Attack, called CCA). The former is called CPA-security and the latter is called CCA security.

The secure block cipher with an adjusting value is a key technology for implementing a sophisticated encryption function. Non-Patent Literature 2, for example, shows that, with the use of the block cipher with an adjustment value, having CCA-security, it is possible to implement efficient authenticated encryption. It also shows that, with the use of the block cipher with an adjustment value, having CPA-security, it is possible to implement an efficient, parallelable message authentication code. In addition, the block cipher with an adjusting value, which provides for CCA-security, is a technology required for storage encryption such as a disk sector encryption.

In the present specification, the mode proposed by a theorem (2) of Non-Patent Literature 1 is called an LRW mode. FIG. 7 shows a schematic view for illustrating encryption and decryption in the LRW mode that uses an n-bit block cipher E as represented in the Non-Patent Literature 1. Given a key K, a tweak T and a plaintext M in the LRW mode that uses an n-bit block cipher, with an encryption function Enc and a decryption function Dec, a ciphertext C is obtained by the following equation (2):

C=Enc(K1,M+F(K2,T))+F(K2,T) (2)

On the other hand, decryption from the ciphertext C to the plaintext M is by the following equation (3):

M=Dec(K1,C+F(K2,T))+F(K2,T) (3)

In the above equations, K1 is a key for the block cipher and K2 is a keyed function F to be added before and after the block cipher processing. K2 is also called an offset function. Noted that, as for F, the following equation (4):

Pr[f(K,x)+f(K,x′)=c]≦e (4)

is to be satisfied for a security parameter e not less than 0 and not greater than 1, and for optional c, x and with x and x′ differing from each other. In this equation, “+” denotes an exclusive OR (XOR).

f(K,*) having this property is called e-AXU (e-almost XOR universal). Note that the e-AXU function is a sort of a universal hash function. To implement this, it is known to set so that F(K2, T)=mul (K2, T), using multiplication mul on the finite field GF (2ⁿ). In this case, F is ½n−AXU.

The e-AXU function may be implemented not only by multiplication mul on the finite field GF (2ⁿ), but also by a system proposed in Non-Patent Literature 3. It is known that, with the use of the above, the operating speed in specified implementation environments may be several times faster than with the conventional block cipher.

### CITATION LIST

### Non-Patent Literature

### Non-Patent Literature 1

M. Liskov, R. Rivest, D. Wagner, “Tweakable Block Ciphers,” Advances in Cryptology—CRYPTO 2002, 22nd Annual International Cryptology Conference, Santa Barbara, Calif., USA, Aug. 18-22, 2002, Proceedings, Lecture Notes in Computer Science 2442, Springer 2002, pp. 31-46.

### Non-Patent Literature 2

P. Rogaway, “Efficient Installations of Tweakable Blockciphers and Refinements to Modes OCB and PMAC,” Advances in Cryptology—ASIACRYPTO 2004, 10th international Conference on the Theory and Application of Cryptology and Information Security, Jeju Island, Korea, Dec. 5-9, 2004, Proceedings, Lecture Notes in Computer Science 3329, Springer 2004, pp. 16-31.

### Non-Patent Literature 3

S. Halevi and H. Krawczyk, “MMH: Software Message Authentication in the Gbit/second rates,” Fast Software Encryption, 4th International Workshop, FSE '97, Lecture Notes in Computer Science, Vol. 1267, February 1997.

### Non-Patent Literature 4

K. Minematsu. “Beyond-Birthday-Bound Security Based on Tweakable Block Cipher,” Fast Software Encryption—FSE 2009, 16th International Workshop, FSE 2009, Leuven, Belgium, Feb. 22-25, 2009, Revised Selected Papers, Lecture Notes in Computer Science 5665, Springer 2009, pp. 308-326.

### SUMMARY

### Technical Problem

The total contents of disclosure of the above mentioned Non-Patent Literatures 1 to 4 are to be incorporated herein by reference thereto. The following is an analysis by the present invention.

In the methods for constructing the tweakable block cipher, employing an n-bit block cipher, there are the LRW mode of Non-Patent Literature 1, and an XEX mode, a variant of the LRW mode, of Non-Patent Literature 2. The LRW mode and the XEX mode are of the forms shown by the equations (2) and (3) and are of the construction approximately identical with each other. However, in the LRW mode, K2 is independent of K1, whereas, in the XEX mode, the result of encrypting a certain plaintext, for example, all-zero n bits, with Enc (K1,*), is used to raise the key size efficiency. Of importance in these modes is that security is assured only for such case where the number of times of encryption operations with a sole key is of a value sufficiently smaller than 2^{n/2}, expressed as q<<2^{1/2}. Note that 2ⁿ⁻² is called a birthday bound. An attack using the result of the number of times q of encryption on the order of the birthday bound is called a birthday attack. Such attack is a real threat in case of using a 64-bit block cipher, and may prove a threat in future even with the use of the 128-bit block cipher. Hence, it is necessary to find proper measures.

An example of such measures is to provide a plurality of keys of the n-bit block cipher from one tweak to another. In particular, the TDR (Tweak-Dependent Rekeying), shown in Non-Patent Literature 4, uses this idea so that, when the tweak length is sufficiently shorter than n/2 bits, there may be provided security (CCA-security) beyond the birthday bound of the block size. FIG. 8 shows the encryption and decryption for TDR. Although the TDR assures high security beyond the birthday bound, the length of the tweak is limited. To assure utility in general, it is desirable to allow for arbitrary lengths of an input to the tweak value.

In the system shown in Non-Patent Literature 1, the length of the tweak is substantially arbitrary. However, the system suffers a problem that security beyond the birthday bound of the block size may not be assured.

As mentioned above, the tweakable block cipher employing a conventional block cipher is vulnerable to birthday attack, even though the tweak length is substantially arbitrary, as in the case of LRW or XEX. Or, the conventional tweakable block cipher is theoretically resistant to the birthday attack, however, the tweak length is limited to a fixed shorter value, as in the case of TDR.

Therefore, there is a need in the art to provide a tweakable block cipher, with an arbitrary tweak length, which is resistant against the birthday attack. It is therefore an object of the present invention to provide an apparatus for block encryption and for block decryption, methods for block encryption and for block decryption, and a corresponding program.

### Solution to Problem

According to a first aspect of the present invention, there is provided a block encryption device comprising:

a keyed hashing unit that receives a b-bit tweak T and generates, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
a tweak dependent key calculating unit that enhances the intermediate value V to n bits on padding, and encrypts the enhanced intermediate value V with the block cipher of n bits, using a key K1, to generate a tweak dependent key L of n bits; and
a masked block encryption unit that adds the mask value S to a plaintext M of n bits to generate a first value, encrypts the first value with the n-bit block cipher having the tweak dependent key L as a key to generate a second value, and adds the mask value S to the second value to generate a ciphertext C.

According to a second aspect of the present invention, there is provided a block decryption device comprising:

a keyed hashing unit that receives a b-bit tweak T and generates, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
a tweak dependent key calculating unit that enhances the intermediate value V to n bits on padding, and encrypts the enhanced intermediate value V with the block cipher of the n bits, using a key K1, to generate a tweak dependent key L of n bits; and
a masked block decryption unit that adds the mask value S to a ciphertext C of n bits to generate a first value, decrypts the first value with the n-bit block cipher having the tweak dependent key L as a key to generate a second value, and adds the mask value S to the second value to generate a plaintext M.

According to a third aspect of the present invention, there is provided a method for block encryption comprising:

by a computer, receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a plaintext M of n bits to generate a first value, encrypting the first value with the n-bit block cipher having the tweak dependent key L as a key to generate a second value, and adding the mask value S to the second value to generate a ciphertext C.

According to a fourth aspect of the present invention, there is provided a method for block decryption comprising:

by a computer, receiving a b-bit tweak and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a ciphertext M of n bits to generate a first value, decrypting the first value with the n-bit block cipher having the tweak dependent key L as a key to generate a second value, and adding the mask value S to the second value to generate a plaintext M.

According to a fifth aspect of the present invention, there is provided a program, causing a computer to execute:

receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n hits on padding, and encrypting the enhanced intermediate value V with the block cipher of the n hits, using a key K1, to generate a tweak dependent key L of hits; and
adding the mask value S to a plaintext M of n bits to generate a first value, encrypting the first value with the n-bit block cipher having the tweak dependent key L as a key to generate a second value, and adding the mask value S to the second value to generate a ciphertext C

According to a sixth aspect of the present invention, there is provided a program, causing a computer to execute:

receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a ciphertext C of n bits to generate a first value, decrypting the first value with the n-bit block cipher having the tweak dependent key L as a key to generate a second value, and adding the mask value S to the second value to generate a plaintext M.

### ADVANTAGEOUS EFFECTS OF INVENTION

With the devices and methods for tweakable block encryption and decryption, and the program, according to the present invention, it is possible to implement a tweakable block cipher which has theoretical resistance against birthday attack and in which the tweak may be of an arbitrary length.

### BRIEF DESCRIPTION OF THE DRAWINGS

FIG. 1 is a schematic block diagram showing a configuration of a first exemplary embodiment.

FIG. 2 is a schematic diagram showing a configuration of the first exemplary embodiment.

FIG. 3 is a flowchart showing an operation of the first exemplary embodiment.

FIG. 4 is a schematic block diagram showing a configuration of a second exemplary embodiment.

FIG. 5 is a schematic diagram showing a configuration of the second exemplary embodiment.

FIG. 6 is a flowchart showing an operation of the second exemplary embodiment.

FIG. 7 is a schematic diagram showing encryption and decryption in an LRW mode according to Non-Patent Literature 1.

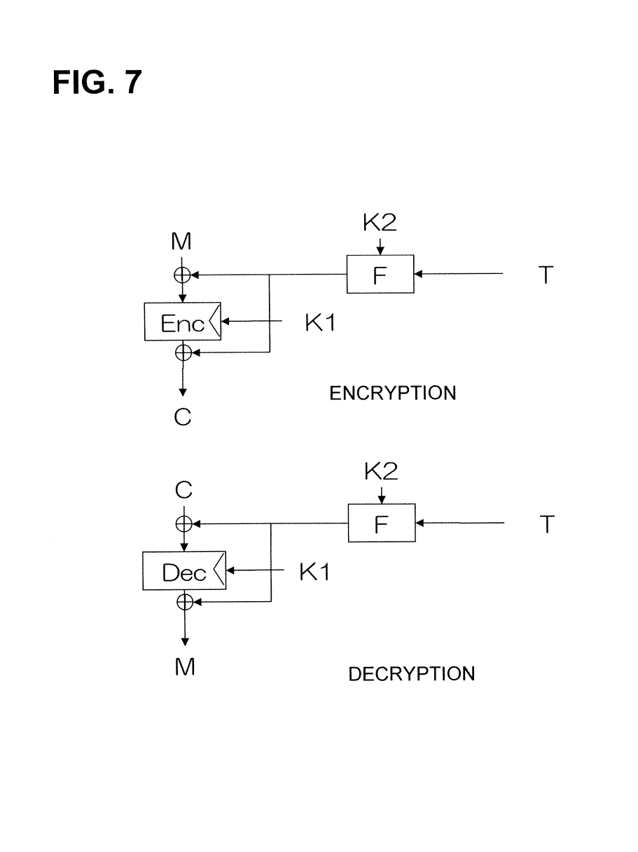

FIG. 8 is a schematic diagram showing encryption and decryption in a TDR mode according to Non-Patent Literature 4.

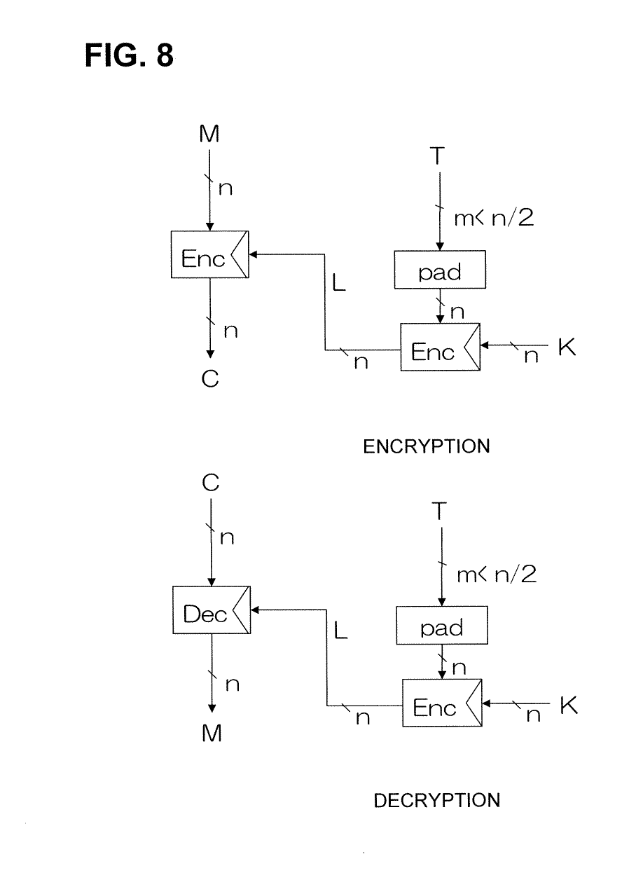

### MODES

### First Exemplary Embodiment

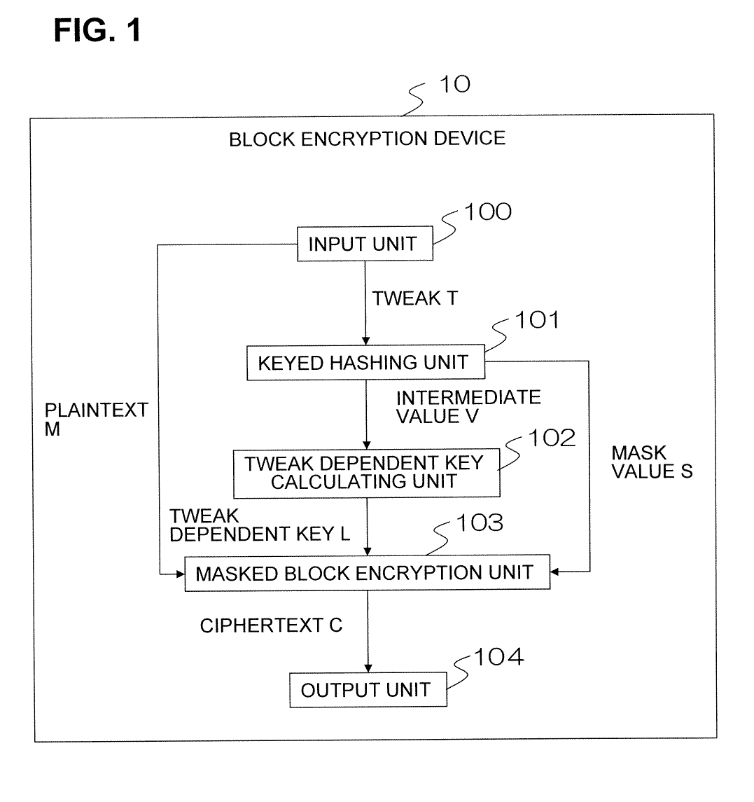

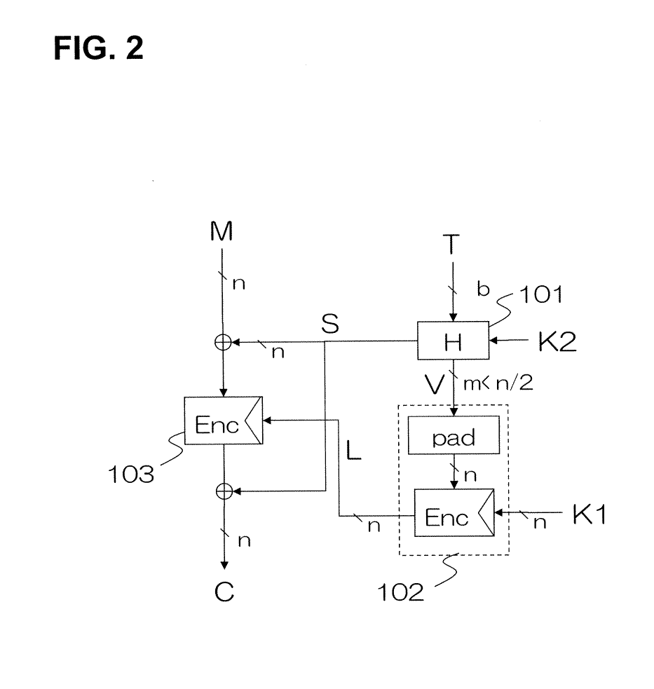

A device for block encryption according to a first exemplary embodiment will now be described with reference to the drawings. FIG. 1 depicts a schematic block diagram showing a configuration of a tweakable block encryption device 10 of the present exemplary embodiment. FIG. 2 is a schematic diagram showing a configuration of the tweakable block encryption device 10.

Referring to FIG. 1, the block encryption device 10 includes an input unit 100, a keyed hashing unit 101, a tweak dependent key calculating unit 102, a masked block encryption unit 103 and an output unit 104.

The block encryption device 10 may be implemented by, for example, a CPU, a memory and a disk.

The various parts of the block encryption device 10 may be implemented by having a program stored on the disk and by allowing the program to be executed on the CPU.

The various parts that make up the block encryption device 10 will now be explained in detail.

In the block cipher used, a block length is n hits, with a key length being n bits. A tweak length is b bits, with b being an arbitrary positive integer. A value of m (1≦m≦n/2), as a security parameter, determines the security.

The input unit 100 inputs an n-bit plaintext M being encrypted and a b-bit tweak T. The input unit 100 may be implemented by a letter input device, such as a keyboard.

Referring to FIGS. 1 and 2, the keyed hashing unit 101 inputs the tweak T to generate an n-bit mask value S and an m-bit intermediate value V, using a keyed hash function H which uses a key K2.

The keyed hash function H is such a function in which, with pairs of the mask values and the intermediate values corresponding to two arbitrary tweaks T, T′ being (S, V) and (S′, V′), respectively, a probability:

Pr[S+S′=c,V=V′]≦e (5)

where S+S′ represents bit-based exclusive-OR of S and S′, will hold for any values of T, T′ and c. It is noted that e is of a value sufficiently close to 2^{-(n+m)}.

For the above representation (5) to hold, it is sufficient that H satisfies the property termed the e-AXU function. As a practical method for this, in case b is not greater than n+m, it is sufficient that the key K2 is formed by n+m bits and T is enhanced to n+m bits on padding, then T resulting from the padding being multiplied (mul) with K2 on the finite field GF (2^{n+m}) to take out S and V therefrom. In this case, e is 2^{-(n+m)}.

In place of multiplication (mul) on the finite field GF (2^{n+m}), such a system proposed in Non-Patent Literature 3 may be used to implement the e-AXU function. It is known that, with the use of the above, the operating speed may be several times faster than with the conventional block cipher in specified implementation environments.

The tweak dependent key calculating unit 102 generates a new key L for block cipher, called a tweak dependent key, using the intermediate value V and the key K1.

Specifically, with the encryption function for the block cipher being Enc (x, y), with x being a key and y being plaintext, the tweak dependent key L becomes

L=Enc(K1,pad(V)) (6)

(see FIG. 2). Note that pad means a padding function that turns the m-bit input into n-bits on padding. The padding function may, for example, be such a function that pads 0s in rear of input m bits.

Referring to FIGS. 1 and 2, the masked block encryption unit 103 encrypts the plaintext M into the ciphertext C, using the tweak dependent key L output from the tweak dependent key calculating unit 102 and the mask value S output from the keyed hashing unit 101.

In more concrete terms, the ciphertext C is such that

C=Enc(L,M+S)+S (7)

The output unit 104 outputs the ciphertext C delivered from the masked block encryption unit 103. The output unit 104 may be implemented by, for example, a computer display, a printer or the like.

In case the present invention is specifically applied to encryption for communication or for data storage, it may be envisaged to use the block cipher of an n-bit block size with a b-bit tweak, provided by the present invention, in some cipher mode or other. For example, it is possible to use the block cipher in Tweak Block Chaining, Tweak Chain Hash or Tweakable Authenticated Encryption, which are tweakable block cipher modes shown in Non-Patent Literature 1.

Moreover, in encryption of a data storage device, such as hard disk, it is possible to apply such a mode discussed in connection with standardization of the storage encryption system in IEEE. The mode is such a one in which encryption is carried out in parallel, as in the ECB (Electronic Code Book) mode, as a mask value is incremented in response to a sector in the hard disk and to a byte position in the sector, where each sector is normally 512 bytes. In this method, it is supposed for example that, with n=128, an encryption function of the tweakable block cipher of a 128 bit block size, with a 128 bit tweak, obtained by the present invention, is expressed as TENC (the encryption with a key K, a tweak T and a plaintext M is TENC (K, T, M)). Initially, the contents of the sector are divided in terms of 128 bits (16 bytes) as a unit. The results of the division are denoted (m₁, m₂, m₃₂), with mᵢ being 16 bytes. In this case, mᵢ (i=1, . . . 32) is encrypted by TENC (K, (SecNum∥i), mᵢ), where SecNum is a sector number and ∥ denotes concatenation of bit sequences. Viz., the i'th block of the sector number SecNum is encrypted with a tweak (SecNum∥i).

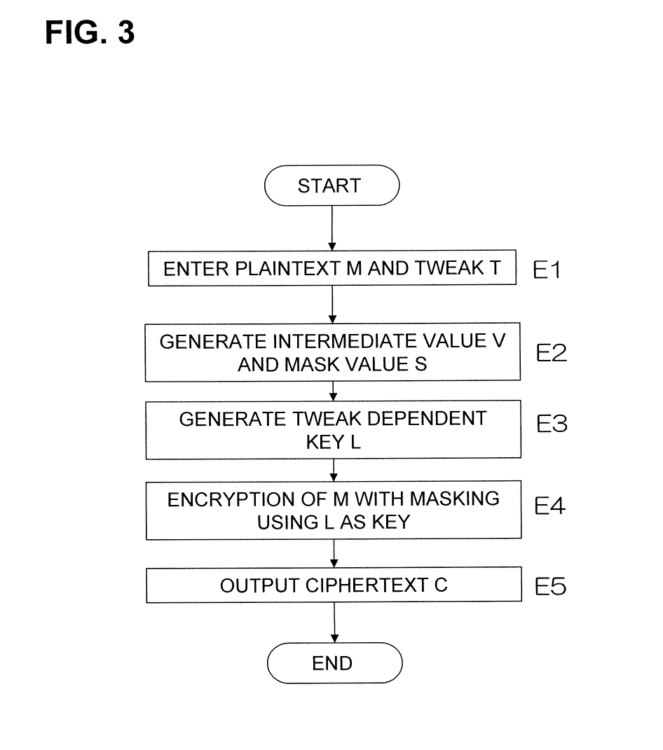

A global operation of the block encryption device of the present exemplary embodiment will now be described with reference to the drawings. FIG. 3 depicts a flowchart showing the global operation of the block encryption device of the present exemplary embodiment.

Referring to FIG. 3, the input unit 100 inputs an n-bit plaintext M and a b-bit tweak T (step E1).

The keyed hashing unit 101 then generates an m-bit intermediate value V, where 1<m<n/2, and an n-bit mask value S (step E2).

The tweak dependent key calculating unit 102 enhances the intermediate value V into n bits by padding. The tweak dependent key calculating unit then encrypts the so padded intermediate value to find an n-bit tweak dependent key L (step E3).

The masked block encryption unit 103 then performs encryption of M with masking, in accordance with the equation (7), with L being the key and with S being a mask value, such as to yield a ciphertext C (step E4).

Finally, the output unit 104 outputs the ciphertext C obtained (step E5).

In the block encryption device 10 of the present exemplary embodiment, for the block cipher of an n-bit block size, with a key being of n bits, the tweak dependent key L and the n-bit mask value S are derived in a manner dependent on the adjusting value (tweak), and are used to encrypt the plaintext. The plaintext is encrypted by the block cipher in which L is used as key. In encrypting the plaintext, exclusive-OR with S is carried out before and after the encryption by the key L. Specifically, the tweak T is delivered to a universal hash function that outputs n+m bits in order to obtain an n-bit S and an m-bit intermediate value V. The intermediate value V is then enhanced to n bits by padding. The key L may then be obtained by encrypting the value V with the block cipher. If, in the above method, a secure block cipher of an n-bit block size, with an n-bit key, as component, is used, and the security parameter m is less than n/2, the probability that an attacker doing 2^{n/2} times of chosen ciphertext attack winning in the attack may be suppressed to 2^{-m/2} at most. Hence, the tweakable block encryption device 10 of the present exemplary embodiment possesses theoretical resistance against birthday attack in case the block size is n (CCA—security).

### Second Exemplary Embodiment

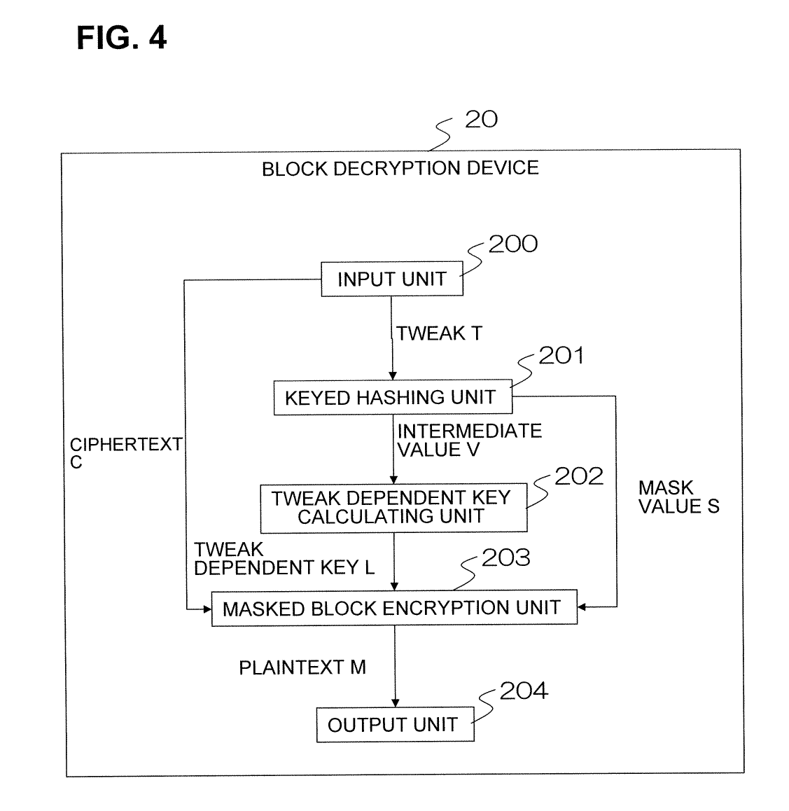

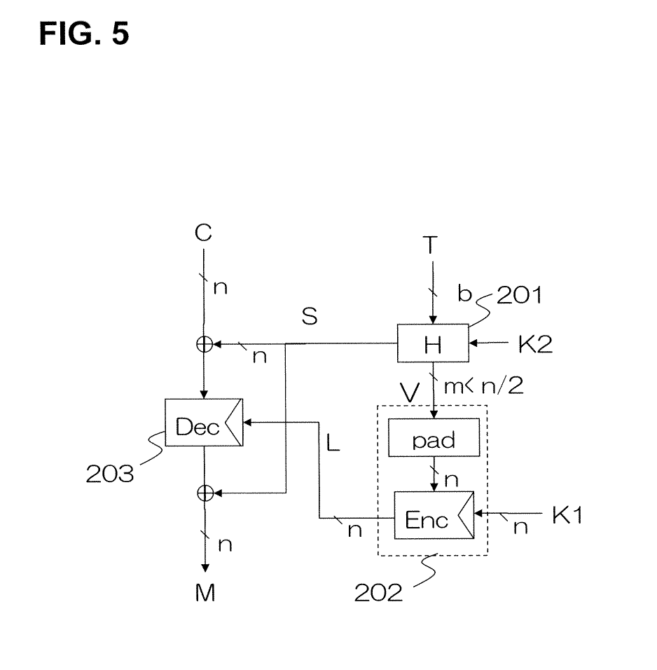

A block decryption device according to a second exemplary embodiment will now be described with reference to the drawings. FIG. 4 is a schematic block diagram showing a configuration of a tweakable block decryption device 20 of the present exemplary embodiment. FIG. 5 is a schematic diagram showing a configuration of the tweakable block decryption device 20.

Referring to FIG. 4, the tweakable block decryption device 20 includes an input unit 200, a keyed hashing unit 201, a tweak dependent key calculating unit 202, a masked block decryption unit 203 and an output unit 204.

The block decryption device 20 may be implemented by a CPU, a memory and a disk.

The components of the block decryption device 20 may be implemented by having a program stored in the disk and by allowing the program to be run on the CPU.

The components of the block decryption device 20 will now be described in detail.

In the block cipher used, the bit block size is n bits, the key is n bits and the tweak is of a length of b bits, b being an optional positive integer. If m (1<m<n/2) is a security parameter, the value of this parameter decides the security.

The input unit 200 inputs an n-bit ciphertext C being decrypted and a b-bit tweak T. The input unit 200 may be implemented by a letter input device, such as a keyboard.

Referring to FIGS. 4 and 5, the keyed hashing unit 201 and the tweak dependent key calculating unit 202 respectively perform the operations similar to those performed by the keyed hashing unit 101 and the tweak dependent key calculating unit 102 (FIGS. 1 and 2) in the block encryption device 10 of the first exemplary embodiment.

Referring to FIGS. 4 and 5, the masked block decryption unit 203 decrypts the ciphertext C into the plaintext M, using the tweak dependent key L output by the tweak dependent key calculating unit 202 and the mask value S output by the keyed hashing unit 201.

Specifically, if the decryption function is expressed as Dec (x, y), where x is a key and y is a ciphertext, the plaintext M becomes

M=Dec(L,C+S)+S (8)

The output unit 204 outputs the plaintext M delivered from the masked block decryption unit 203. The output unit 204 may be implemented by a computer display, a printer or the like.

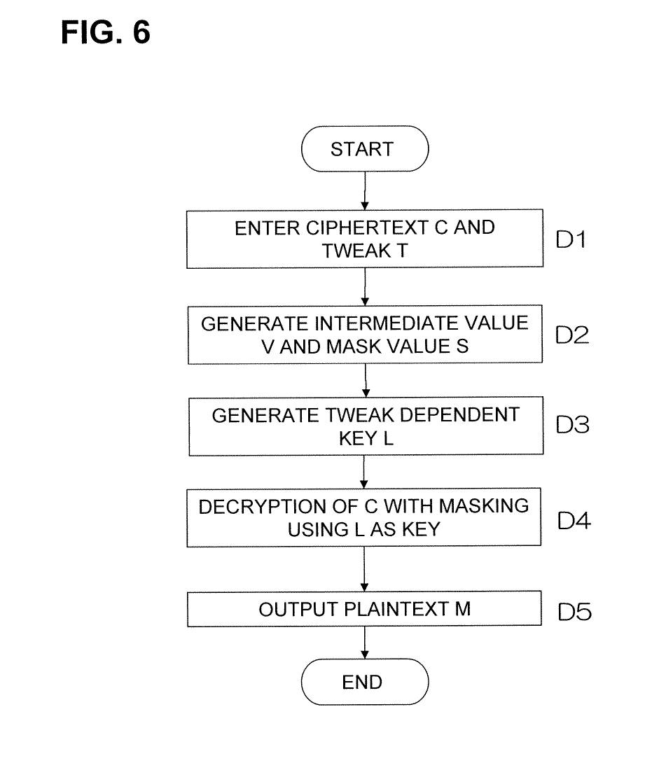

The global operation of the block decryption device 20 of the present exemplary embodiment will now be described with reference to the drawings. FIG. 6 depicts a flowchart showing a global operation of the block decryption device 20 of the present exemplary embodiment.

Referring to FIG. 6, the input unit 200 inputs an n-bit ciphertext C and a b-bit tweak T (step D1).

The keyed hashing unit 201 generates an m-bit intermediate value V, where 1<m<n/2, and an n-bit mask value S (step D2).

The tweak dependent key calculating unit 202 then enhances the intermediate value V to n bits on padding and encrypts the so padded intermediate value V to find an n-bit tweak dependent key L (step D3).

The masked block decryption unit 203 then performs decryption with masking of C in accordance with the equation (8), with the Key L and with the mask value S, such as to obtain the plaintext M (step D4).

Finally, the output unit 204 outputs the plaintext M obtained (step D5).

The block encryption device 10 of the first exemplary embodiment and the block decryption device 20 of the second exemplary embodiment may be implemented by a computer and a program running thereon.

According to the present invention, a tweakable block cipher, with a tweak of an arbitrary length, guaranteeing the beyond-birthday-bound security, may be implemented efficiently.

The reason may be summarized as follows: It is now supposed that the block cipher E of the proposed system, with the block size being n bits, is used as component, with the block cipher E being theoretically secure and m<n<n/2 being a security parameter. In this case, the cipher is theoretically secure in case the number of plaintext-ciphertext pairs, used by an attacker, is sufficiently smaller than 2^{(n+m)/2}, viz., the cipher is theoretically resistant against birthday attack by 2^{n/2} times of encryption operations. Note that m stands for a parameter controlling the strength of the resistance and may be set so that m=n/3, as set out in Non-Patent Literature 4.

This security may be guaranteed by using the TDR stated in Non-Patent Literature 4 as a module. In the TDR, the tweak dependent key L is derived on directly encrypting the result obtained on padding of the m-bit tweak. According to the present invention, the tweak is delivered to a keyed hash function that outputs n+m bits, of which the n bits are used as mask value of LRW of Non-Patent Literature 1 and the remaining m bits are used as tweak in TDR. By so doing, the beyond-birthday-hound theoretical security may be guaranteed in the same way as in TDR. In addition, the present invention is featured by the fact that the tweak is of an arbitrary length, as in LRW.

The disclosure of the above Non-Patent Literatures is incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept.

The block encryption device and the block decryption device according to the present invention may be applied to authentication and encryption in wired or wireless data communication or to encryption as well as prevention of falsification of data on a storage system.

Part of all of the above described exemplary embodiments may be recited as the following examples of execution, only in a non-limiting fashion.

### Example of Execution 1

A block encryption device comprising:

a keyed hashing unit that receives a b-bit tweak T and generates, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
a tweak dependent key calculating unit that enhances the intermediate value V to n bits on padding, and encrypts the enhanced intermediate value V with the block cipher of n bits, using a key K1, to generate a tweak dependent key L of n bits; and
a masked block encryption unit that adds the mask value S to a plaintext M of n bits to generate a first value, encrypts the first value with the n-bit block cipher having the tweak dependent key L as a key to generate a second value, and adds the mask value S to the second value to generate a ciphertext C.

### Example of Execution 2

The block encryption device according to example of execution 1, wherein

the keyed hash function H is such a function in which, when pairs of mask values and intermediate values corresponding to two optional tweaks T, T′ differing from each other are (S, V) and (S′, V′), S+S′ denotes bit-based exclusive-OR of S and S′ and e is of a value sufficiently close to 2^{-(n+m)}, a probability

Pr[S+S′=c,V=V′]≦e

holds for optional values of T, T′ and c.

### Example of Execution 3

The block encryption device according to example of execution 1 or 2, wherein,

the tweak dependent key calculating unit pads n−m bits of 0s in rear of the intermediate value V.

### Example of Execution 4

The block encryption device according to any one of examples of execution 1 to 3, further comprising:

an input unit that receives the tweak T and the plaintext M.

### Example of Execution 5

The block encryption device according to any one of examples of execution 1 to 4, further comprising:

an output unit that outputs the ciphertext C.

### Example of Execution 6

A block decryption device comprising:

a keyed hashing unit that receives a b-bit tweak T and generates, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
a tweak dependent key calculating unit that enhances the intermediate value V to n bits on padding, and encrypts the enhanced intermediate value V with the block cipher of the n bits, using a key K1, to generate a tweak dependent key L of n bits; and
a masked block decryption unit that adds the mask value S to a ciphertext C of n bits to generate a first value, decrypts the first value with the n-bit block cipher having the tweak dependent key L as a key to generate a second value, and adds the mask value S to the second value to generate a plaintext M.

### Example of Execution 7

The block decryption device according to example of execution 6, wherein

the keyed hash function H is such a function in which, when pairs of mask values and intermediate values corresponding to two optional tweaks T, T′ differing from each other are (S. V) and (S′, V′), S+S′ is bit-based exclusive-OR of S and S′ and e is of a value sufficiently close to 2^{-(n+m)}, a probability

Pr[S+S′=c,V=V′]≦e

holds for optional values of T, T′ and c.

### Example of Execution 8

The block decryption device according to example of execution 6 or 7, wherein,

the tweak dependent key calculating unit pads n−m bits of 0s in rear of the intermediate value V.

### Example of Execution 9

The block decryption device according to any one of examples of execution 6 to 8, further comprising:

an input unit that receives the tweak T and the ciphertext C.

### Example of Execution 10

The block decryption device according to any one of examples of execution 6 to 9, further comprising:

an output unit that outputs the plaintext M.

### Example of Execution 11

A method for block encryption comprising:

by a computer, receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a plaintext M of n bits to generate a first value, encrypting the first value with the n-bit block cipher having the tweak dependent key L as a key to generate a second value, and adding the mask value S to the second value to generate a ciphertext C.

### Example of Execution 12

The method for block encryption according to example of execution 11, further comprising:

receiving the tweak T and the plain ext M via an input unit.

### Example of Execution 13

The method for block encryption according to example of execution 11 or 12, further comprising:

outputting the ciphertext C to the output unit.

### Example of Execution 14

A method for block decryption comprising:

by a computer, receiving a b-bit tweak and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a ciphertext M of n bits to generate a first value, decrypting the first value with the n-bit block cipher having the tweak dependent key L as a key to generate a second value, and adding the mask value S to the second value to generate a plaintext M.

### Example of Execution 15

The method for block encryption according to example of execution 14, further comprising:

receiving the tweak T and the ciphertext C via an input unit.

### Example of Execution 16

The method for block encryption according to example of execution 14 or 15, further comprising:

outputting the plaintext M to the output unit.

### Example of Execution 17

A program, causing a computer to execute:

receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of bits; and
adding the mask value S to a plaintext M of n bits to generate a first value, encrypting the first value with the n-bit block cipher having the tweak dependent key L as a key to generate a second value, and adding the mask value S to the second value to generate a ciphertext C.

### Example of Execution 18

The program according to example of execution 17, further causing the computer to execute:

receiving the tweak T and the plaintext M via an input unit.

### Example of Execution 19

The program according to example of execution 17 or 18, further causing the computer to execute:

outputting the ciphertext C to an output unit.

### Example of Execution 20

A program, causing a computer to execute:

receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a ciphertext C of n bits to generate a first value, decrypting the first value with the n-bit block cipher having the tweak dependent key L as a key to generate a second value, and adding the mask value S to the second value to generate a plaintext M.

### Example of Execution 21

The program according to example of execution 20, further causing the computer to execute:

receiving the tweak T and the plaintext m via an input unit.

### Example of Execution 22

The program according to example of execution 20 or 21, further causing the computer to execute:

outputting the plaintext M to an output unit.

### Example of Execution 23

A computer readable recording medium in which there is recorded the program according to any one of examples of execution 17 to 22.

### REFERENCE SIGNS LIST

10 block encryption device
20 block decryption device
100, 200 input unit
   101, 201 keyed hashing unit
   102, 202 tweak dependent key calculating unit
103 masked block encryption unit
104, 204 output unit
203 masked block encryption unit
C ciphertext
Dec, TWDEC decryption function
Enc, TWENC, TENC encryption function
F keyed function
e-AXU function
GF(*) finite field
hash function
K1, K2 keys
L tweak dependent key
M plaintext
mul multiplication
pad padding function
S, S′ mask value
SecNum sector number
T, T′ tweak
V, V′ intermediate value

What is claimed is:

1. A block encryption device comprising:
a keyed hashing unit that receives a b-bit tweak T and generates, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
a tweak dependent key calculating unit that enhances the intermediate value V to n bits on padding, and encrypts the enhanced intermediate value V with the block cipher of n bits, using a key K1, to generate a tweak dependent key L of n bits; and
a masked block encryption unit that adds the mask value S to a plaintext M of n bits to generate a first value, encrypts the first value with the n-bit block cipher having the tweak dependent key L as a key to generate a second value, and adds the mask value S to the second value to generate a ciphertext C.

2. The block encryption device according to claim 1, wherein
the keyed hash function H is such a function in which, when pairs of mask values and intermediate values corresponding to two optional tweaks T, T′ differing from each other are (S, V) and (S′, V′), S+S′ denotes bit-based exclusive-OR of S and S′ and e is of a value sufficiently close to 2^{-(n+m)}, a probability
Pr[S+S′=c,V=V′]≦e
holds for optional values of T, T′ and c.

3. The block encryption device according to claim 1 or 2, wherein,
the tweak dependent key calculating unit pads n−m bits of 0s in rear of the intermediate value V.

4. The block encryption device according to claim 1, further comprising:
an input unit that receives the tweak T and the plaintext M.

5. The block encryption device according to claim 1, further comprising:
an output unit that outputs the ciphertext C.

6. A block decryption device comprising:
a keyed hashing unit that receives a b-bit tweak T and generates, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
a tweak dependent key calculating unit that enhances the intermediate value V to n bits on padding, and encrypts the enhanced intermediate value V with the block cipher of the n bits, using a key K1, to generate a tweak dependent key L of n bits; and
a masked block decryption unit that adds the mask value S to a ciphertext C of n bits to generate a first value, decrypts the first value with the n-bit block cipher having the tweak dependent key L as a key to generate a second value, and adds the mask value S to the second value to generate a plaintext M.

7. The block decryption device according to claim 6, wherein
the keyed hash function H is such a function in which, when pairs of mask values and intermediate values corresponding to two optional tweaks T, T′ differing from each other are (S, V) and (S′, V′), S+S′ is bit-based exclusive-OR of S and S′ and e is of a value sufficiently close to 2^{-(n+m)}, a probability
Pr[S+S′=c,V=V′]≦e
holds for optional values of T, T′ and c.

8. The block decryption device according to claim 6, wherein,
the tweak dependent key calculating unit pads n−m bits of 0s in rear of the intermediate value V.

9. A method for block encryption comprising:
by a computer, receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a plaintext M of n bits to generate a first value, encrypting the first value with the n-bit block cipher having the tweak dependent key L as a key to generate a second value, and adding the mask value S to the second value to generate a ciphertext C.

10. A method for block decryption comprising:
by a computer, receiving a b-bit tweak and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a ciphertext M of n bits to generate a first value, decrypting the first value with the n-bit block cipher having the tweak dependent key L as a key to generate a second value, and adding the mask value S to the second value to generate a plaintext M.

11. A program, causing a computer to execute:
receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a plaintext M of n bits to generate a first value, encrypting the first value with the n-bit block cipher having the tweak dependent key L as a key to generate a second value, and adding the mask value S to the second value to generate a ciphertext C.

12. A program, causing a computer to execute:
receiving a b-bit tweak T and generating, by a keyed hash function employing a key K2, a mask value S of n bits and an intermediate value V of m bits, m being a positive integer less than n/2; with a block cipher being of a block size of n bits, with key length being n bits and with the tweak being of a length of b bits;
enhancing the intermediate value V to n bits on padding, and encrypting the enhanced intermediate value V with the block cipher of the n bits, using a key K1, to generate a tweak dependent key L of n bits; and
adding the mask value S to a ciphertext C of n bits to generate a first value, decrypting the first value with the n-bit block cipher having the tweak dependent key L as a key to generate a second value, and adding the mask value S to the second value to generate a plaintext M.
